(19) United States
(12) Patent Application Publication
(10) Pub. No.: US 2012/0054126 A1
(43) Pub. Date: Mar. 1, 2012

(54) Business method for popularity creation and marketing

(75) Inventors: Marina GAZETOVA, Visaginas (LT); Liudmila GAZETOVA, Visaginas (LT); Rafael GAZETOV, Visaginas (LT)

(73) Assignee: UAB IEEC, Vilnius (LT)

(21) Appl. No.: 12/873,414

(22) Filed: Sep. 1, 2010

(51) Int. Cl. G06Q 90/00

(52) U.S. Cl. 705/500

(57) ABSTRACT

A business method for popularity creation and marketing includes the steps of the following process: transferring popularity (rating, celebrity, reputation, exclusive, fame, importance, prestige) from a popularity bearer with higher rate of popularity to a popularity bearer with lower rate of popularity (rating); increasing the rate of popularity of the popularity bearer who transfers his/her own popularity; increasing the rate of popularity of the popularity bearer who receives another person's popularity; increasing the number of bearers who receive popularity from the popularity bearer who transfers popularity; creating, via computer, telecommunication system or other ways, a new compound product of certain design between them. The created compound product includes permanent and variable parts. The permanent part includes data, features, attributes or other characteristics of the bearer who transfers his/her own popularity; the variable part includes data, features, attributes or other characteristics of the bearer who receives another person's popularity.

### FIELD OF THE INVENTION

The present invention can be widely used in different fields and human activity spheres, in all community groups, for example, business, science, sport, art, culture, music, and other spheres which are common for celebrity and his/her worshippers, fans.

### BACKGROUND

The global society is divided into famous people, celebrities, idols, brands, and their fans and worshippers. All of them have different level of popularity, rating, celebrity, reputation, exclusive, fame, importance, prestige or trust in different groups of society. A famous person or brand is a bearer of his/her own popularity, rating, reputation, prestige and trust among his/her fans and worshippers.

Famous people or brands have high level of popularity (rating, celebrity, reputation, exclusive, fame, importance, prestige), while their fans lack it. Celebrities include many promoted brands, famous writers, sportsmen, musicians, actors, politicians, businessmen, and other famous people.

The level of their popularity, rating, reputation, prestige and trust in society grows first, then reaches its maximum at some point of time, and finally begins to decrease, i.e. it is characterized by certain popularity rating and popularity life cycle.

Famous people or brands have multimillion audience of worshippers, fans, or other people who are positive to them. Celebrities are bearers of their own popularity and have certain rating. Worshippers and fans are also bearers of their own popularity and rating. The only difference is in the level of their popularity and rating in society.

The level of celebrities' popularity (rating, celebrity, reputation, exclusive, fame, importance, prestige) is high, and they seek to increase the level of their popularity (rating) constantly and to stay at the peak of popularity (rating) for as long as possible, i.e. they want to increase the popularity (rating) life cycle.

The level of fans' popularity (rating) is very low or close to zero. The majority of them want to be close to their favorite celebrities, to be associated with them, to feel being part of this elite group. Fans and worshippers constantly try to find different ways of getting closer to the celebrities and to be part of their group on mutually beneficial basis. Fans and worshippers are ready to pay the celebrities for opportunity to get and increase the level of their popularity (rating) in society.

Thus, there is need for forming a market of popularity (rating) as a virtual product. Such market of popularity (rating) will allow exchange of popularity between the bearers, so there is need for creating a mechanism for exchange, transfer, and increase of popularity (rating).

### SUMMARY OF THE INVENTION

In the present invention, creation of popularity (rating, celebrity, reputation, exclusive, fame, importance, prestige) is performed by transfer of existing popularity (rating, celebrity, reputation, exclusive, fame, importance, prestige) from a bearer or bearers with higher level of popularity (rating, celebrity, reputation, exclusive, fame, importance, prestige) to a bearer or bearers with lower level of popularity (rating, celebrity, reputation, exclusive, fame, importance, prestige);

In the present invention, during the process of transfer of popularity (rating, celebrity, reputation, exclusive, fame, importance, prestige) from a bearer with higher level of popularity (rating, celebrity, reputation, exclusive, fame, importance, prestige) to a bearer with lower level of popularity (rating, celebrity, reputation, exclusive, fame, importance, prestige), the level of popularity (rating, celebrity, reputation, exclusive, fame, importance, prestige) of the bearer who transfers popularity (rating, celebrity, reputation, exclusive, fame, importance, prestige) increases;

In the present invention, during the process of transfer of popularity (rating, celebrity, reputation, exclusive, fame, importance, prestige) from a bearer with higher level of popularity (rating, celebrity, reputation, exclusive, fame, importance, prestige) to a bearer with lower level of popularity (rating, celebrity, reputation, exclusive, fame, importance, prestige), the level of popularity (rating, celebrity, reputation, exclusive, fame, importance, prestige) of the bearer who receives popularity (rating, celebrity, reputation, exclusive, fame, importance, prestige) increases;

In the present invention, during the process of transfer of popularity (rating, celebrity, reputation, exclusive, fame, importance, prestige) from a bearer with higher level of popularity (rating, celebrity, reputation, exclusive, fame, importance, prestige) to a bearer with lower level of popularity (rating, celebrity, reputation, exclusive, fame, importance, prestige), the life cycle of popularity (rating, celebrity, reputation, exclusive, fame, importance, prestige) of the bearer who transfers popularity (rating, celebrity, reputation, exclusive, fame, importance, prestige) increases;

In the present invention, during the process of transferring popularity (rating, celebrity, reputation, exclusive, fame, importance, prestige) from a bearer with higher level of popularity (rating, celebrity, reputation, exclusive, fame, importance, prestige) to a bearer with lower level of popularity (rating, celebrity, reputation, exclusive, fame, importance, prestige), the life cycle of popularity (rating, celebrity, reputation, exclusive, fame, importance, prestige) of the bearer who receives popularity (rating, celebrity, reputation, exclusive, fame, importance, prestige) increases;

In the present invention, creating popularity (rating, celebrity, reputation, exclusive, fame, importance, prestige) is performed by increasing the number of bearers who receive popularity (rating, celebrity, reputation, exclusive, fame, importance, prestige) from the bearer who transfers popularity (rating, celebrity, reputation, exclusive, fame, importance, prestige);

In the present invention, the process of transfer of popularity (rating, celebrity, reputation, exclusive, fame, importance, prestige) from a bearer with higher level of popularity (rating, celebrity, reputation, exclusive, fame, importance, prestige) to a bearer with lower level of popularity (rating, celebrity, reputation, exclusive, fame, importance, prestige) is accompanied by creating, via computer, telecommunication system or other means, a visual or sound united product between the bearer who transfers popularity (rating, celebrity, reputation, exclusive, fame, importance, prestige) and the bearer who receives popularity (rating, celebrity, reputation, exclusive, fame, importance, prestige).

In the present invention, the created united product comprises permanent and variable parts. The permanent part comprises data, attributes, or other characteristics of the popularity bearer who transfers his/her popularity (rating, celebrity, reputation, exclusive, fame, importance, prestige); the variable part comprises data, attributes or other characteristics of the bearer who receives another person's popularity (rating, celebrity, reputation, exclusive, fame, importance, prestige).

In the present invention, examples of created compound products are the following:
1 Compound domain name of level 1 (compound sub-domain) or level 2
2 Compound mobile phone number
3 Compound brand, compound trademark, logotype or other compound mark
4 Compound virtual (quasi) money, for example based on existing banknote design
5 Compound song or compound video product
6 Compound exclusives
7 Compound spaces (duration) of time

### BRIEF DESCRIPTION OF THE DRAWINGS

FIG. 1 is a comprehensive scheme showing the following:
1 process of popularity (rating) transferring from a bearer or bearers with higher level of popularity (rating, celebrity, reputation, exclusive, fame, importance, prestige) to a bearer or bearers with lower level of popularity (rating, celebrity, reputation, exclusive, fame, importance, prestige);
2 process of increasing the level of popularity (rating, celebrity, reputation, exclusive, fame, importance, prestige) of both parts (synergetic effect);
3 process of increasing the life cycle of popularity (rating, celebrity, reputation, exclusive, fame, importance, prestige) of both parts (synergetic effect);
4 process of creating compound products between them;
5 process of increasing the number of bearers who receive popularity (rating, celebrity, reputation, exclusive, fame, importance, prestige);

FIG. 2 is a comprehensive scheme showing a process of creating, via computer, telecommunication system or other means, a compound product between a bearer with higher level of popularity (rating, celebrity, reputation, exclusive, fame, importance, prestige) and bearers with lower level of popularity (rating, celebrity, reputation, exclusive, fame, importance, prestige);

FIG. 3A is scheme showing an example of a created compound product between Celebrity, on example Gerard Depardieu, and his worshipper 1, in the form of compound virtual money based on existing euro banknote;

FIG. 3B is scheme showing an example of a created compound product between Celebrity, on example Gerard Depardieu, and his worshipper 2, in the form of compound virtual money based on existing euro banknote;

### DESCRIPTION OF PREFERRED EMBODIMENT

Next, with reference to the accompanying drawings, a popularity, rating creation and marketing business method according to an embodiment of the present invention will be described.

FIG. 1 is a scheme explaining process of popularity (rating, celebrity, reputation, exclusive, fame, importance, prestige) creation and marketing where Popularity Bearer A (1), having initial Popularity Level (2, colored blue) and Initial Life Cycle T1, transferring (3, dashed blue arrow) his/her own popularity to Popularity Bearer 1 (4), having initial Popularity Level (rating) (5, colored red); During the process of popularity transfer there is increasing united Popularity Level (rating) (6, colored blue); Besides there is creating (7) Compound Product 1 (8) between Popularity Bearer A and Popularity Bearer 1; Then, Popularity Bearer A transferring (9, dashed blue arrow) his/her own popularity to Popularity Bearer 2 (10), having initial Popularity Level (11, colored red); During the process of popularity transfer there is increasing united Popularity Level (12, colored blue); Besides there is creating (13) Compound Product 2 (14) between popularity bearer A and Popularity Bearer 2; Then, the process of transferring popularity, changing the level of popularity, and creating a compound product may be repeated endlessly, i.e.: Popularity Bearer A transferring (15, dashed blue arrow) his/her own popularity to Popularity Bearer N (16), having initial Popularity Level (17, colored red); During the process of popularity transfer there is increasing united Popularity Level 18, colored blue); Besides there is creating (19) Compound Product N (20) between Popularity Bearer A and Popularity Bearer N;

FIG. 1 is a scheme explaining how a synergetic effect occurs during the process of popularity transfer, the level of popularity of Bearer A increases from initial Popularity Level (2) to final Popularity Level (21), and the life cycle of popularity increases from Initial Life Cycle TO to final Life Cycle TN. The level of popularity of Bearers 1 also changes (increases) from initial Popularity Level (5) to final Popularity Level (6), and the life cycle of popularity increases from Initial Life Cycle tO final Life Cycle t1. The level of popularity of Bearers 2 also changes (increases) from initial Popularity Level (11) to final Popularity Level (12), and the life cycle of popularity increases from Initial Life Cycle tO to final Life Cycle t2. Then, the process of changing the level and life cycle of popularity may be repeated endlessly, i.e.: The level of popularity of Bearers N increases from initial Popularity Level (17) to final Popularity Level (18), and the life cycle of popularity increases from Initial Life Cycle tO to final Life Cycle tN.

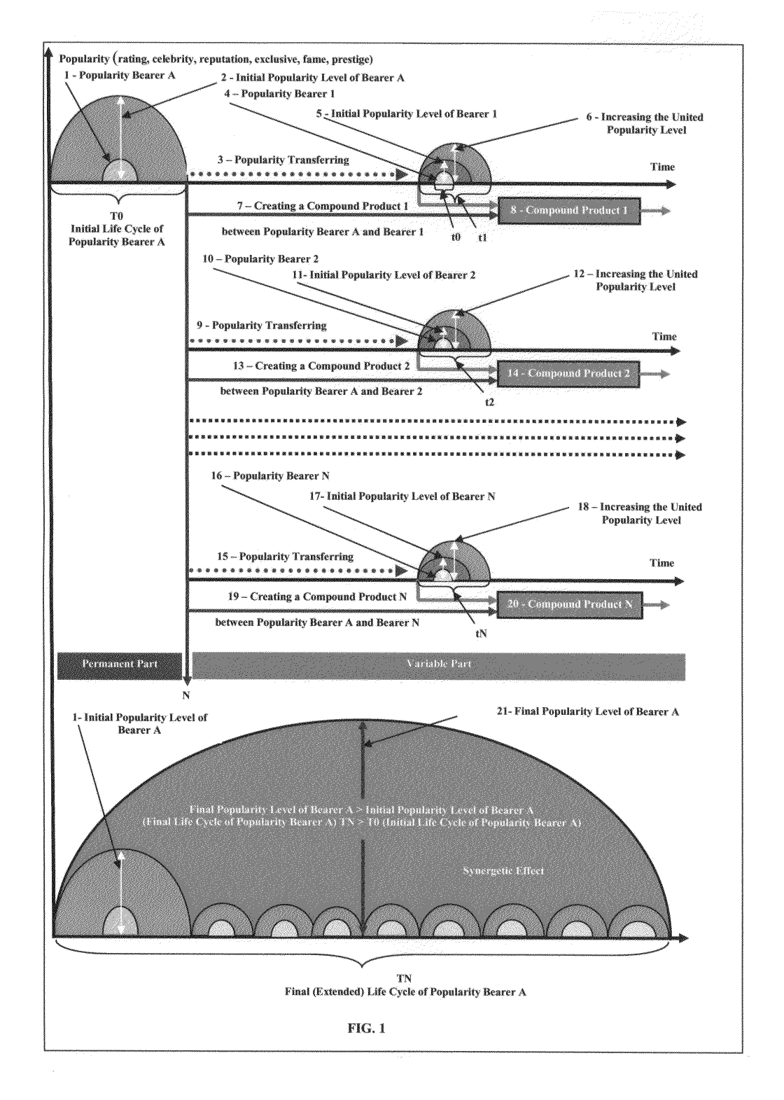

FIG. 2 is a scheme explaining the process of Compound Product creating, via computer, telecommunication system or other means, where Popularity Bearer A (1) creates (2) with Popularity Bearer 1 (3) compound product 1 (6); then, Popularity Bearer A creates (2) with Popularity Bearer 2 (4) compound product 2 (7); then, the process of creating a compound product may be repeated endlessly, i.e.: Popularity Bearer A creates (2) with Popularity Bearer N (5) compound product N (8); the compound product contains permanent part (9) and variable part (10).

FIG. 2 is a scheme showing the process of Compound Product creating, via computer (11) as follows: Compound Domain Name (Sub domain) of Level I (12) contains variable part (13), which comprises data, properties, attributes or other characteristics of Popularity Bearer 1, 2, 3 . . . N and contains permanent part (14), which comprises data, properties, attributes, or other characteristics of Popularity Bearer A, Example 1 (15);

FIG. 2 is a scheme showing the process of Compound Product creating, via computer (11) as follows: Compound Domain Name of Level II (16) contains variable part (17), which comprises data, properties, attributes or other characteristics of Popularity Bearer 1, 2, 3 . . . N and contains permanent part (18), which comprises data, properties, attributes, or other characteristics of Popularity Bearer A, Example 2 (19);

FIG. 2 is a scheme showing the process of Compound Product creating, via computer (20) as follows: Compound Brand (21), example 3, contains variable part (22), which comprises data, properties, attributes or other characteristics of Popularity Bearer 1, 2, 3 . . . N and contains permanent part (23), which comprises data, properties, attributes, or other characteristics of Popularity Bearer A;

FIG. 2 is a scheme showing the process of Compound Product creating, via computer (20) as follows: Compound Virtual (Quasi) Money (24), example 4, contains variable part (25), which comprises data, properties, attributes or other characteristics of Popularity Bearer 1, 2, 3 . . . N and contains permanent part (26), which comprises data, properties, attributes, or other characteristics of Popularity Bearer A;

FIG. 2 is a scheme showing the process of Compound Product creating, via telecommunication system (27) as follows: Compound Mobile Phone Number (28), example 5, contains Country Code (29); contains permanent part (30), which comprises Zone Code (for example—101), which belong to Popularity Bearer A; contains variable part (31), which comprises Phone Numbers, which belong to Popularity Bearers 1, 2, 3 . . . N;

FIG. 2 is a scheme showing the process of Compound Sound or Video Product creating, via telecommunication system (33) as follows: Compound Song or Video Product (34), example 6, contains variable part (35), which comprises data, properties, attributes, or other characteristics of Popularity Bearer 1, 2, 3 . . . N; contains permanent part (36), which comprises data, properties, attributes or other characteristics of Popularity Bearer A.

FIG. 2 is a scheme showing the process of Compound Product creating, via other means (37) as follows: Compound Exclusive, Compound Spaces (Duration) of Time, example 7 (38), contains variable part (39), which comprises data, properties, attributes, or other characteristics of Popularity Bearer 1, 2, 3 . . . N; contains permanent part (40), which comprises data, properties, attributes or other characteristics of Popularity Bearer A.

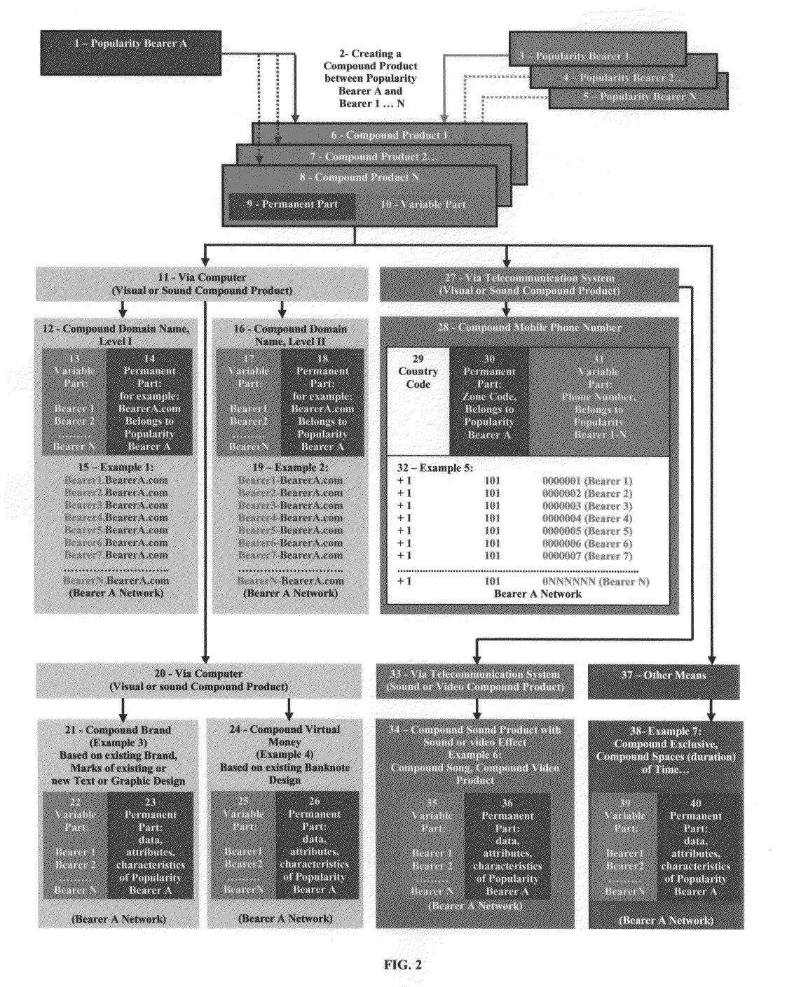

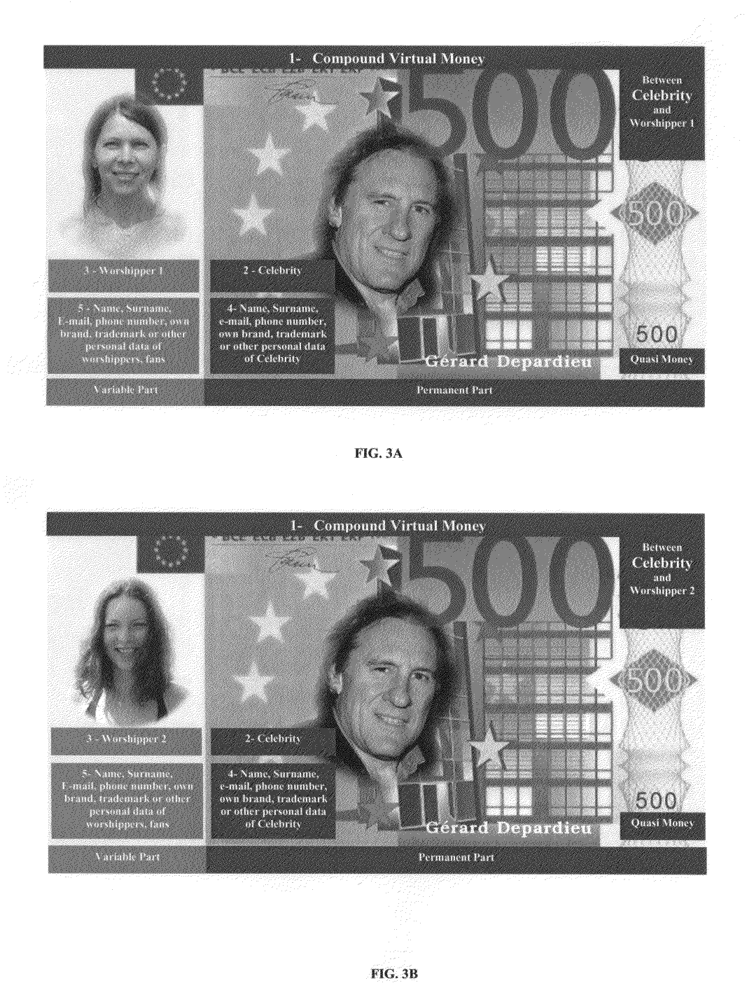

FIG. 3A is a scheme showing an example of Compound Virtual Money (1) based on existing design of 500 Euro's banknote, created between Celebrity (2) (Gerard Depardieu) and his worshipper 1 (3), where permanent part comprises data (4) (name, surname, e-mail, phone number, brand, trademark or other personal characteristics) of Celebrity (Gerard Depardieu), and variable part, comprises data (5) (name, surname, e-mail, phone number, brand, trademark or other personal characteristics) of Worshipper 1.

FIG. 3B is a scheme showing an example of Compound Virtual Money (1) based on existing design of 500 Euro's banknote, created between Celebrity (2) (Gerard Depardieu) and his worshipper 2 (3), where permanent part comprises data (4) (name, surname, e-mail, phone number, brand, trademark or other personal characteristics) of Celebrity (Gerard Depardieu), and variable part, comprises data (5) (name, surname, e-mail, phone number, brand, trademark or other personal characteristics) of Worshipper 2.

### CONCLUSION

The present invention is meant to reach the following goals:
1 To intensify the exchange of popularity (rating, celebrity, reputation, exclusive, fame, importance, prestige) between the bearers at a growing popularity market;
2 To increase popularity (rating, celebrity, reputation, exclusive, fame, importance, prestige) of the bearers who transfer their own popularity (rating, celebrity, reputation, exclusive, fame, importance, prestige) (as a result of the synergetic effect);
3 To increase popularity (rating, celebrity, reputation, exclusive, fame, importance, prestige) of the bearers who receive another person's popularity (rating) (as a result of the synergetic effect);
4 To increase life cycle of popularity (rating) of the bearers who transfer their own popularity (rating, celebrity, reputation, exclusive, fame, importance, prestige) (as a result of the synergetic effect);
5 To increase life cycle of popularity (rating) of the bearers who receive another person's popularity (rating, celebrity, reputation, exclusive, fame, importance, prestige) (as a result of the synergetic effect);
   6 To convert popularity (rating, celebrity, reputation, exclusive, fame, importance, prestige) into benefits or profits of the bearers.

Thus, the present invention is an instrument for exchange and transfer of popularity (rating, celebrity, reputation, exclusive, fame, importance, prestige) between their bearers, as well as for conversion of popularity (rating, celebrity, reputation, exclusive, fame, importance, prestige) into benefits or rofits of the bearers.

What is claimed is:

1. A method for popularity creation and marketing comprises the steps of: transferring popularity (rating, celebrity, reputation, exclusive, fame, importance, prestige) from a popularity bearer with higher rate of popularity (rating, celebrity, reputation, exclusive, fame, importance, prestige) to a popularity bearer with lower rate of popularity (rating, celebrity, reputation, exclusive, fame, importance, prestige); increasing the rate of popularity (rating, celebrity, reputation, exclusive, fame, importance, prestige) of the popularity bearer who transfers his/her own popularity; increasing the rate of popularity (rating, celebrity, reputation, exclusive, fame, importance, prestige) of the popularity bearer who receives another person's popularity; increasing the number of bearers who receive popularity from the popularity bearer who transfers popularity; creating, via computer, telecommunication system or other means, a new compound product of certain design between the bearer or bearers who transfer popularity and the bearer or bearers who receive popularity.

2. The business method according to claim 1, whereas the created compound product comprises permanent and variable parts. The permanent part comprises data, features, attributes or other characteristics of the bearer who transfers his/her own popularity; the variable part comprises data, features, attributes or other characteristics of the bearer who receives another person's popularity.
